(19) United States
(12) Patent Application Publication
(10) Pub. No.: US 2026/0361747 A1
(43) Pub. Date: Nov. 12, 2026

(54) SELF-CONTAINED EDR CONFIGURATION AND DEPLOYMENT IN AUTONOMOUS PENTESTING

(71) Applicant: Horizon 3 AI, Inc., Dover, DE (US)

(72) Inventors: James Walter Horseman, Wesley Chapel, FL (US); Zachary Daniel Hanley, Apex, NC (US); Naveen Naga Sunkavally, Cary, NC (US); Snehal Antani, San Francisco, CA (US)

(21) Appl. No.: 19/201,067

(22) Filed: May 7, 2025

(51) Int. Cl. H04L 9/40

(52) U.S. Cl. CPC H04L 63/1433

(57) ABSTRACT

An autonomous pentesting agent may execute an autonomous pentest of a network, where executing the autonomous pentest includes: performing one or more autonomous pentesting operations along an attack path, and accessing an endpoint of multiple endpoints of the network via the attack path. The agent may generate an endpoint detection and response (EDR) payload based on one or more parameters of the endpoint, one or more attributes of an environment surrounding the endpoint, and a complexity level associated with accessing the endpoint via the one or more autonomous pentesting operations along the attack path. The agent may deploy, via the attack path and during the autonomous pentest, an EDR agent including the EDR payload at the endpoint, where the EDR agent is configured to disable after an expiry condition is met.

### BACKGROUND

In networking, penetration testing or “pentesting” refers to conducting security operations that simulate a cybersecurity attack in order to identify vulnerabilities in a network. The goal of pentesting is to mimic the actions of a malicious actor and discover loopholes or other vulnerabilities before they can be exploited. Pentesting may include techniques such as scanning for vulnerabilities, testing system configurations and security protocols, and attempting controlled attacks to evaluate defense mechanisms within a network. Network administrators can remediate vulnerabilities uncovered during pentesting to prevent malicious actors from compromising network security using those vulnerabilities. Practicing regular pentesting can aid in maintaining high security standards, protecting sensitive data, and ensuring the continuity of network services.

### SUMMARY

The described techniques relate to improved methods, systems, devices, and apparatuses that support self-contained endpoint detection and response (EDR) configuration and deployment in autonomous pentesting.

In some aspects, the techniques described herein relate to a method for autonomous pentesting, including: executing an autonomous pentest of a network, wherein executing the autonomous pentest includes: performing one or more autonomous pentesting operations along an attack path; and accessing an endpoint of a plurality of endpoints of the network via the attack path; generating an EDR payload based at least in part on one or more parameters of the endpoint, one or more attributes of an environment surrounding the endpoint, and a complexity level associated with accessing the endpoint via the one or more autonomous pentesting operations along the attack path; and deploying, via the attack path and during the autonomous pentest, an EDR agent including the EDR payload at the endpoint, wherein the EDR agent is configured to disable after an expiry condition is met.

In some aspects, the techniques described herein relate to an apparatus for autonomous pentesting, including: one or more memories storing processor-executable code; and one or more processors coupled with the one or more memories and individually or collectively operable to execute the code to cause the apparatus to: execute an autonomous pentest of a network, wherein, to execute the autonomous pentest, the one or more processors are individually or collectively further operable to execute the code to cause the apparatus to: perform one or more autonomous pentesting operations along an attack path; and access an endpoint of a plurality of endpoints of the network via the attack path; generate an EDR payload based at least in part on one or more parameters of the endpoint, one or more attributes of an environment surrounding the endpoint, and a complexity level associated with accessing the endpoint via the one or more autonomous pentesting operations along the attack path; and deploy, via the attack path and during the autonomous pentest, an EDR agent including the EDR payload at the endpoint, wherein the EDR agent is configured to disable after an expiry condition is met.

In some aspects, the techniques described herein relate to a non-transitory computer-readable medium storing code for autonomous pentesting, the code including instructions executable by one or more processors to: execute an autonomous pentest of a network, wherein, to execute the autonomous pentest, the instructions are further executable by the one or more processors to: perform one or more autonomous pentesting operations along an attack path; and access an endpoint of a plurality of endpoints of the network via the attack path; generate an EDR payload based at least in part on one or more parameters of the endpoint, one or more attributes of an environment surrounding the endpoint, and a complexity level associated with accessing the endpoint via the one or more autonomous pentesting operations along the attack path; and deploy, via the attack path and during the autonomous pentest, an EDR agent including the EDR payload at the endpoint, wherein the EDR agent is configured to disable after an expiry condition is met.

### BRIEF DESCRIPTION OF THE DRAWINGS

FIG. 1 shows an example of a computing environment that supports self-contained endpoint detection and response (EDR) configuration and deployment in autonomous pentesting in accordance with aspects of the present disclosure.

FIG. 2 shows an example of an autonomous pentest map that supports self-contained EDR configuration and deployment in autonomous pentesting in accordance with aspects of the present disclosure.

FIG. 3 shows an example of a computing environment that supports self-contained EDR configuration and deployment in autonomous pentesting in accordance with aspects of the present disclosure.

FIGS. 4 and 5 show examples of pentesting flow diagrams that support self-contained EDR configuration and deployment in autonomous pentesting in accordance with aspects of the present disclosure.

FIG. 6 shows a diagram of a system including a device that supports self-contained EDR configuration and deployment in autonomous pentesting in accordance with aspects of the present disclosure.

FIG. 7 shows a flowchart illustrating methods that support self-contained EDR configuration and deployment in autonomous pentesting in accordance with aspects of the present disclosure.

### DETAILED DESCRIPTION

Some networks may include endpoint detection and response (EDR) systems. An EDR system may record and store behaviors of one or more endpoints of a network, detect security threats based on such behaviors, block malicious activity, and generate or suggest remediation actions. In other words, the EDR system may detect and respond to security threats at one or more endpoints of a network. An EDR system may include one or more EDR agents. An EDR agent may refer to an entity configured to monitor behaviors of an endpoint, block malicious activity at that endpoint, and communicate with a management console of the EDR system. An EDR system may include a management console and multiple EDR agents deployed at different endpoints of a network that report back to the management console. An endpoint may refer to a physical or virtual device connected to a network and functioning as a starting or ending point for data communications. For example, an endpoint may be a mobile device, desktop computer, virtual machine, embedded device, server, or a component thereof having a communicative connection to the network.

In some cases, the EDR system may be manually configured and/or deployed. That is, a user of the network or a security team may manually tune EDR agents, select endpoints for EDR agent deployment, and install the EDR agents. However, manually configuring and deploying an EDR system may be time and resource intensive. In other words, developing a persistent (e.g., long-lived) EDR system that calls back to a management console and covers multiple endpoints may be a slow and resource intensive process. In such cases, though a pentesting agent may identify endpoints vulnerable to attack during a pentest, such endpoints may remain vulnerable as EDR agents or an EDR system is manually configured after the conclusion of the pentest. For example, a pentesting agent may identify one or more projected attack paths involving one or more endpoints and, after the pentest, the user or security team of the network may manually configure and deploy the EDR agents at such endpoints. Accordingly, weaknesses may persist after they are identified during pentesting, leaving the endpoints vulnerable to attack even after their vulnerabilities are identified.

As described herein, an autonomous pentesting agent may autonomously deploy EDR agents during an autonomous pentest as vulnerable endpoints are identified, closing a gap between vulnerability identification and remediation. For example, the autonomous pentesting agent may access an endpoint during an attack path and gather information about the endpoint, including parameters of the endpoint (the type of device, frequency and/or type of data traffic, etc.), attributes of the environment surrounding the endpoint (e.g., connected or accessible network assets), and a complexity level associated with accessing the endpoint (e.g., complexity of an attack path to the endpoint). Based on the information, the autonomous pentesting agent may generate an EDR payload. For example, the autonomous pentesting agent may generate an EDR payload for an EDR agent to be deployed to the endpoint based on the information obtained through the attack path. The EDR agent may be a short-lived, self-contained EDR agent. That is, the EDR agent may be configured to disable after an expiry condition is met and may operate independently of an EDR system or management console. By deploying the EDR agent during the pentest after endpoints are identified as being vulnerable to attack, the autonomous pentesting agent may remediate endpoint vulnerabilities more quickly and using fewer resources than other EDR agent deployment mechanisms (e.g., manual configuration and deployment), thereby improving network security.

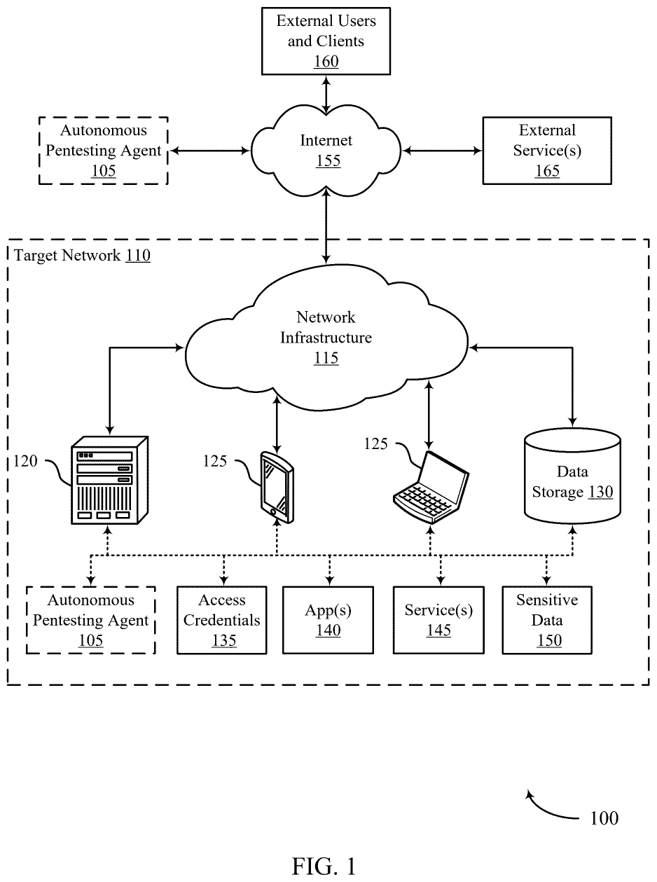

FIG. 1 illustrates an example of a computing environment 100 that supports self-contained EDR configuration and deployment in autonomous pentesting in accordance with aspects of the present disclosure. The computing environment 100 may include an autonomous pentesting agent 105 that performs an autonomous pentest of a target network 110. The target network 110 may include one or more devices or systems, such as a network infrastructure 115, server 120, computing devices 125, data storage 130, or any combination thereof. The devices or systems of the target network 110 may be configured to access or provide various network information and services, such as access credentials 135, app(s) 140, service(s) 145, sensitive data 150, or any combination thereof.

The target network 110 may allow the server 120, the computing devices 125, and the data storage 130 to communicate (e.g., exchange information) with one another. For example, the network infrastructure 115 may include any quantity of communications links and any quantity of hubs, bridges, routers, switches, ports, or other physical or logical network components that support communication between the server 120, computing devices 125, and data storage 130 of the target network 110 as well as communication between the target network 110 (e.g., the private network) and the Internet 155 or other external network (outside the target network 110, beyond a firewall associated with the target network 110, etc.). The target network 110 may include aspects of one or more wired networks, one or more wireless networks (e.g., cellular networks, Wi-Fi networks), or any combination thereof. The target network 110 may include aspects of one or more public networks or private networks, as well as secured or unsecured networks, or any combination thereof. For example, the target network 110 may be an example of a private network that includes one or more public-facing or external assets that are accessible via the Internet 155. As an example, the Internet 155 may refer to the world wide web, and users (e.g., external users and clients 160), may access the target network 110 via the Internet 155 through a website or application that is accessible or available via the Internet 155. For instance, the external users and clients 160, the external service(s) 165, or both may access network information and services via the Internet 155, including the access credentials 135, app(s) 140, service(s) 145, and sensitive data 150.

The target network 110 may be, or may be part of, a domain, such as a private domain associated with an organization, company, client, business, etc., defining an administrative boundary of the target network 110. The domain may include components such as computing devices 125, the server 120, etc., along with associated users (e.g., access credentials 135) and service(s) 145 that are governed or configured by one or more domain controllers and operate in accordance with policies that are put in place and managed by the one or more domain controllers. The domain may be divided into multiple subdomains or groups containing respective subsets of components, users (e.g., access credentials 135), and service(s) 145 that operate in accordance with a respective policy (e.g., group policy).

The target network 110 may be accessible via one or more hosts. For example, hosts may be examples of real or virtual machines that are connected to and capable of accessing the target network 110. Real machines may refer to machines having or made up of hardware components including a central processing unit (CPU), memory, hard drive, or the like, such as physical or tangible computers or servers (e.g., the server 120, the computing devices 125, etc.). Virtual machines may refer to software within or running on a physical computer or server using portions of the CPU, memory, hard drive, or the like of the physical computer or server. A physical computer or server may include or support multiple virtual machines, such as multiple tenants (e.g., in a multi-tenant environment). The server 120 and the computing devices 125 may be examples of hosts. Hosts may communicate data with other devices within the target network 110 and outside of the network (e.g., with devices accessible via the Internet 155). For example, the server 120 may send data to and receive data from one or more of the computing devices 125. Additionally, or alternatively, hosts may access resources of the target network 110, including the access credentials 135, app(s) 140, service(s) 145, or sensitive data 150. As used herein, hosts may refer to web hosts, cloud hosts, virtual hosts, remote hosts, or the like.

Hosts may be examples of and include network assets. For example, a host may be an example of a type of network asset that has access to other network assets, such as applications, services, and resources. As used herein, network assets refer to data, devices, or components of the target network 110, including data, software, and hardware. In some examples, network assets may refer to machines that include network shares. For example, network assets may be examples of machines (e.g., real or virtual machines) that include shares of the target network 110, such as file sharing systems. Network assets may be obtained and utilized by attackers to compromise the target network 110. In some cases, network assets may refer to network entities (e.g., system hosts or machines) that have internet protocol (IP) addresses and may be discovered during scans. The server 120, the computing devices 125 (e.g., laptops, desktops, mobile devices, smart vehicles, wearables), the data storage 130, and the access credentials 135, app(s) 140, service(s) 145, cookies, encryption and decryption keys, tokens, and sensitive data 150 accessible via the devices and systems of the target network 110 may all be examples of network assets. Other examples of network assets include virtual machines, printers, Internet-of-Things (IoT) devices, switches, routers, access points, endpoints, public static IPs, Lambdas and serverless architectures, Amazon Web Service (AWS) containers, and Kubernetes pods and other containerized applications. For example, physical devices (e.g., servers, computing devices, data storage) and systems may be considered network assets as well as information, apps, and services accessible through physical devices and systems of the target network 110.

Hosts may store, provide, or implement access credentials 135, app(s) 140, service(s) 145, sensitive data 150, or any combination thereof. In some cases, computing devices 125 on the network may access the one or more network assets (access credentials 135, app(s) 140, service(s) 145, sensitive data 150, etc.) via the server 120 (e.g., via a host). Additionally, or alternatively, computing devices 125 may locally store or otherwise access one or more network assets of the target network 110. For example, users of the target network 110 may access app(s) 140 and service(s) 145 via the computing devices 125 directly or indirectly (e.g., via a connection between the computing devices 125 and the server 120).

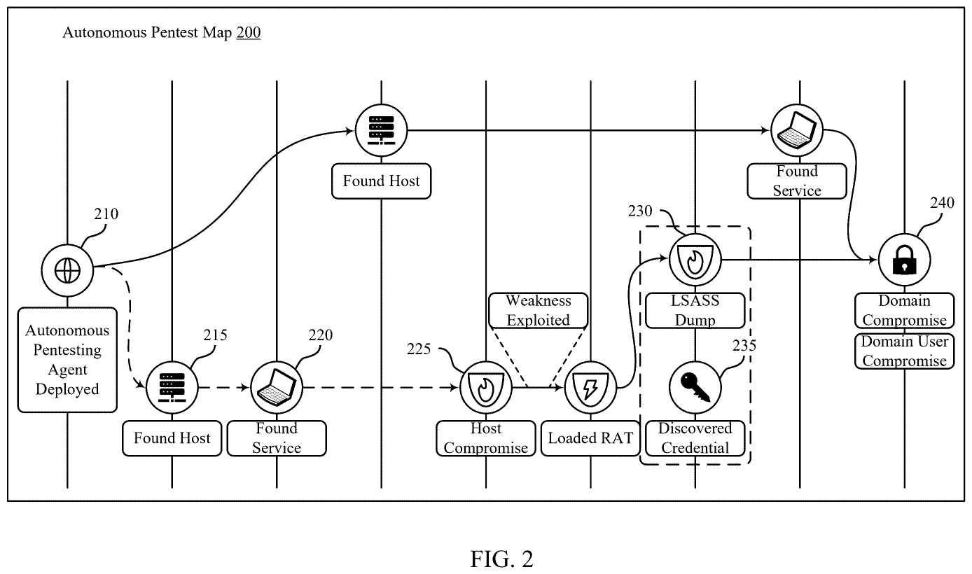

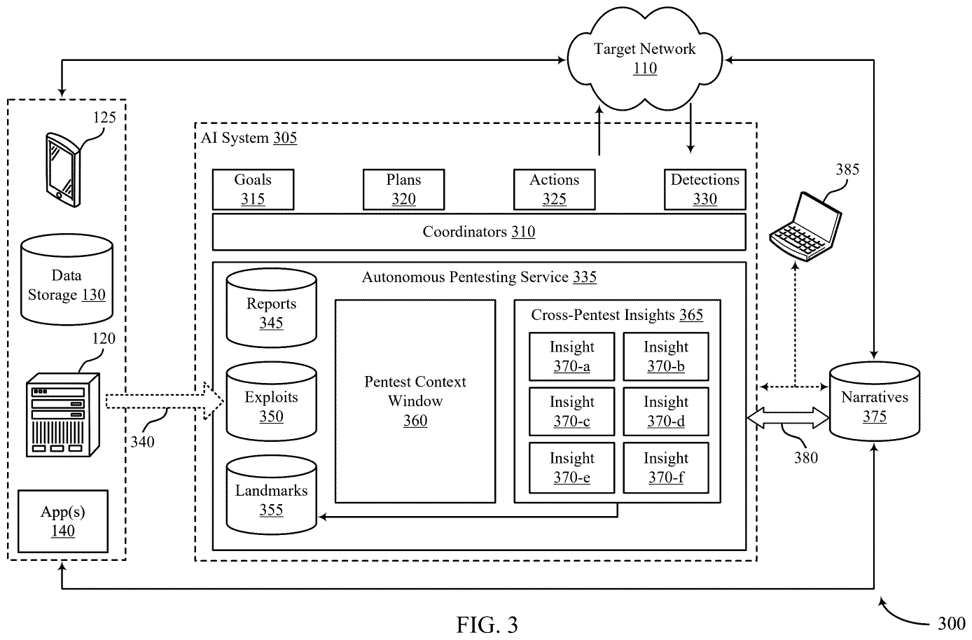

The autonomous pentesting agent 105 may perform a pentest of the target network 110. As used herein, a penetration test or a “pentest” may refer to the performance of one or more security operations that simulate a cybersecurity attack in order to identify vulnerabilities in the target network 110. The autonomous pentesting agent 105 may perform the pentest of the target network 110 using one or more artificial intelligence (AI) models. For example, the autonomous pentesting agent 105 may be “autonomous” in that the autonomous pentesting agent 105 may perform the pentest without hard coding (e.g., deterministic coding), user inputs, or the like and, instead, by using the one or more AI models. The autonomous pentesting agent 105 may identify, via the pentest, security vulnerabilities of the target network 110. An example of an output of the pentest may be described in greater detail elsewhere herein, including with reference to FIGS. 2 and 3.

The autonomous pentesting agent 105 may, via the one or more AI models, determine and implement an attack path for a pentest. For example, the autonomous pentesting agent 105 may identify or select an asset of the target network 110 to attempt to access initially and, from that asset, another asset to attempt to access, and so on. In other words, the autonomous pentesting agent 105 may use the one or more AI models to generate (e.g., output) decisions or operations that mimic those of a potential cyber attacker. The one or more AI models may output a targeted asset of the target network 110 to be subject to an access attempt by the autonomous pentesting agent 105 based on inputs and relevant context of various assets in the target network 110. For instance, the one or more AI models may output targeted assets based on the relative position of assets within the target network 110, asset types, downstream assets (e.g., accessible after or through accessing a targeted asset), or the like.

The one or more AI models may be trained using data of previous pentests of the target network 110 or other networks. For example, an autonomous pentesting service that deploys the autonomous pentesting agent 105 may train one or more AI models used by the autonomous pentesting agent 105 using tactics, techniques, and procedures (TTPs) of attackers (e.g., human or automated pentests), autonomous pentests performed on the target network 110 previously, on other networks, or both. The autonomous pentesting agent 105 may perform improved pentests after the one or more AI models are trained using previous pentests of the target network 110. That is, as the autonomous pentesting agent 105 learns more about the target network 110, the autonomous pentesting agent 105 may perform pentests with higher performance levels (higher accuracy, higher quantities of potential attack paths, etc.).

In some cases, the pentest may be initiated internal (e.g., within) or external to (e.g., outside of a firewall) the target network 110. For example, the autonomous pentesting agent 105 may be deployed at a host device of the target network 110 (e.g., deployed to the server 120 or computing devices 125). In such cases, the autonomous pentesting agent 105 may perform the pentest as an internal user of the target network 110. Such internal pentests may be indicative of or emulate internal security threats to the network, such as from employees of an organization or an attacker that has otherwise access to the target network 110 internally or to a user of the target network 110. Alternatively, the autonomous pentesting agent 105 may be deployed at the Internet 155. For example, the autonomous pentesting agent 105 may perform the pentest as an external user of the target network 110, such as by accessing external or public-facing assets of the target network 110 on the Internet 155. In some examples, the autonomous pentesting agent 105 may be deployed via a runner. For example, a runner may be an executable process, script, or sequence, which enables automated deployment of a container (e.g., a Docker container). A container may refer to an executable package of software including code, runtime, system tools, system libraries, settings, and other components to run an application. The runner and the container may allow a user to provision and deploy pentests from a portal without manually running a launch script for the autonomous pentesting agent 105 (such as in accordance with a pentest schedule).

By performing the pentest autonomously via the autonomous pentesting agent 105, techniques described herein may support improved performance related to speed, identification of security vulnerabilities, and provision of remediation measures. For example, the pentest, when performed autonomously using the autonomous pentesting agent 105, may support improved performance and, by extension, improved security of the target network 110 against cybersecurity attacks relative to hard-coded (e.g., deterministic) or manual (e.g., human operated) pentests.

As described herein, the autonomous pentesting agent 105 may perform an autonomous pentest of the target network 110 during which the autonomous pentesting agent 105 may deploy EDR agent(s) to compromised endpoints. For example, the autonomous pentesting agent may obtain unauthorized access to an endpoint—such as the server 120 and the computing devices 125, among other examples—during an autonomous pentest of the target network 110. The autonomous pentesting agent 105 may generate an EDR payload based on information obtained during pentesting. For example, the autonomous pentesting agent 105 may generate an EDR payload based on parameters of the endpoint, attributes of the environment surrounding the endpoint, and a complexity level associated with accessing the endpoint. The autonomous pentesting agent 105 may deploy an EDR agent including the EDR payload to the accessed endpoint. The EDR agent may be an example of a short-lived, self-contained EDR agent. That is, the EDR agent may be configured to disable (e.g., expire, deactivate, uninstall) after an expiry condition is met—such as an expiration timer or activation of a different type of EDR agent (e.g., an EDR agent configured to communicate with a management console)—and the EDR agent may operate independently of other entities within or external to the target network 110.

By deploying the EDR agent after compromising the endpoint, rather than after the pentest and/or after manual configuration and deployment of the EDR agent, techniques described herein may reduce security risks in the target network 110. Specifically, the autonomous pentesting agent 105 may reduce a time period during which an endpoint may be exposed (e.g., for potential compromise or attack) by deploying an EDR agent during an autonomous pentest. Additionally, the EDR agent may be configured to block operations corresponding to an attack path by which the endpoint was compromised during the pentest. That is, rather than waiting until the conclusion of the autonomous pentest and/or manual configuration of an EDR agent or entire EDR system, the autonomous pentesting agent 105 may deploy an EDR agent configured to block at least the attack path performed by the autonomous pentesting agent 105 as a stop-gap until a subsequent (e.g., manually-configured) EDR agent is deployed to the endpoint. In other words, the autonomous pentesting agent 105 may reduce the risk of the endpoint being compromised through a known attack path during a time period between identification of the attack path and deployment of an EDR agent after the pentest (such as a manually configured EDR agent).

FIG. 2 shows an example of an autonomous pentest map 200 that supports self-contained EDR configuration and deployment in autonomous pentesting in accordance with aspects of the present disclosure. The autonomous pentest map 200 may be an example of an output or result of an autonomous pentest performed by an autonomous pentesting agent, such as a pentest performed by the autonomous pentesting agent 105 in the target network 110 as described with reference to FIG. 1. The autonomous pentest map 200 may illustrate and describe an example of events of a pentest, including operations performed by and information obtained by the autonomous pentesting agent. The autonomous pentest map 200 in the example of FIG. 2 may illustrate a map after completion of a pentest, but in some examples, the autonomous pentesting service may display and update the autonomous pentest map 200 during a pentest as events occur. For example, the autonomous pentesting service may display a real-time view that provides real-time information and updates on the progress of a currently running pentest, including status updates for injected credentials.

The autonomous pentest map 200 may include one or more types of events. In some examples, the autonomous pentest map 200 may illustrate notable events, which may be events that did or would likely (e.g., in a real-time view) lead to a critical impact. For example, the autonomous pentest map 200 may include deployment 210 (e.g., of the autonomous pentesting agent), host identification 215, service identification 220, host compromise 225, deployment of an attacker tool 230 (e.g., a remote access tool (RAT), credential identification 235, and access 240 (e.g., to a domain, a domain user, or both). An attacker tool 230, such as a RAT, may refer to software that enables full control of a tech device remotely. RATs may have legitimate uses, such as technical support, but may also be controlled by attackers with malicious intent. In the context of the autonomous pentesting agent, a RAT may be used to provide the autonomous pentesting agent with additional access to further explore attack paths during operations.

The autonomous pentest map 200 includes one possible attack path including two attack branches that is generated based on an autonomous pentest. However, it is understood that any quantity of possible attack paths having any quantity of possible attack branches may be output from an autonomous pentest. In other words, the autonomous pentest map 200 may include one or more attack paths having one or more respective attack branches. In some cases, dozens, hundreds, or thousands of possible attack paths, branches, or both may be generated based on the autonomous pentest. Additionally, it is understood that while the autonomous pentest map 200 shown in FIG. 2 displays one example of an autonomous pentest for illustration, other maps including various different events, hosts, attack paths, and attack branches may result from various autonomous pentests.

In the example of the autonomous pentest map 200, the autonomous pentesting agent may identify an attack path having two attack branches. As used herein, attack “path” may be understood to refer to a series of events, set in motion by the autonomous pentest agent, that lead to a compromise of one or more components or assets of a network. In other words, an attack path may refer to the sequence of steps or actions an attacker or autonomous pentesting agent 105 may take to compromise a system or network. An attack path may involve identifying vulnerabilities and other weaknesses, exploiting them, and navigating through the target network 110 to access valuable information or resources. Additionally, “branches” or “chains” of an attack path may refer to one or more events occurring simultaneously or in parallel that lead to the compromise. As an example, in a first attack branch of the autonomous pentest map 200, the autonomous pentesting agent may identify a host, identify a service, and compromise the host (e.g., through the service). On the compromised host, the autonomous pentesting agent may exploit a weakness identified on the service running on the host to load a RAT and remotely control the compromised host. The autonomous pentesting agent may perform, via the RAT, a Local Security Authority Subsystem Service (LSASS) dump, allowing the autonomous pentesting agent to discover a credential. The autonomous pentesting agent may use the credential in a different branch of the attack path. For example, in a second attack branch of the autonomous pentest map 200, the autonomous pentesting agent may identify a host and, through the identified host, a service. The autonomous pentesting agent may use the discovered credentials (e.g., of the first attack branch) at the service (e.g., of the second attack branch to obtain access 240 to the domain, domain user, or both.

As used herein, a weakness may refer to a vulnerability or security flaw that may be exploited by an attacker to compromise a system or network. Weaknesses may include misconfigurations, outdated software, default credentials, or other vulnerabilities that may be leveraged to gain unauthorized access or perform malicious actions. Some vulnerabilities may be publicly known. For example, an N-day may be a software or hardware vulnerability that is already publicly known, (e.g., n days since disclosure, where n is a positive integer) but there may or may not be a security update available to remediate the vulnerability. Weaknesses, if exploited, may be associated with impacts. An impact may summarize, in business terms, the effects the autonomous pentesting agent was able to achieve as a result of exploiting weaknesses in an environment. An example of an impact may be a sensitive data exposure, which may indicate that the autonomous pentesting agent was able to potentially access sensitive information given the filetype or service that is compromised (e.g., business documents in file shares, Outlook personal storage table (PST) files, confluence remote code execution (RCE), exchange RCE, etc.).

An autonomous pentesting service may display the autonomous pentest map 200 such that compromised assets may be identified and security measures may be put in place. In some cases, the autonomous pentesting service may provide mitigation recommendations according to the autonomous pentest map 200. As an example, the autonomous pentest map 200 may identify a particular host or service as a security vulnerability for a network by tracing the access 240 backwards to a host identification 215 event. Accordingly, the autonomous pentesting service may provide a mitigation recommendation to be applied to the host involved in the host identification 215 event, such as according to how the host was identified or how access was obtained to the host at the host compromise 225 event. Similarly, the autonomous pentesting service may provide a mitigation recommendation to be applied to the service involved in the service identification 220 event.

The autonomous pentesting service may support deployment of EDR agents during autonomous pentesting. For example, the autonomous pentesting service may access endpoints during an autonomous pentest of a network and obtain information about the endpoints. The autonomous pentesting service may generate an EDR payload based on information about the endpoints, including parameters of the endpoint, attributes of the environment surrounding the endpoint, and a complexity level associated with accessing the endpoint. As an example, the autonomous pentesting service may deploy an EDR agent to the host involved in the host identification 215 event based on the host being compromised. The autonomous pentesting service may deploy the EDR agent during the pentest (e.g., prior to exploiting the weakness, loading the RAT, etc.) such that a time gap between identification of the host as being vulnerable and remediating the vulnerability is shorter than typical or traditional EDR deployment methods, reducing the time during which the endpoint may be exposed or attacked.

FIG. 3 shows an example of a computing environment 300 that supports self-contained EDR configuration and deployment in autonomous pentesting in accordance with aspects of the present disclosure. The computing environment 300 may implement or be implemented by the computing environment 100, the autonomous pentest map 200, or both. For example, the computing environment 300 may include servers 120, computing devices 125, and app(s) 140 utilizing an AI system 305 to perform autonomous pentests.

In some examples, the AI system 305 may be a system designed to process data, learn from past experiences, and make determinations and predictions that mimic human cognitive functions (e.g., from the perspective of a potential cyber attacker). In some cases, the AI system 305 may implement or be implemented by one or more AI or machine learning (ML) models (e.g., AI/ML models). In some examples, an AI/ML model of the AI system 305 may be a supervised learning model configured to learn from labeled training data to generate predictions on inputs. In some other examples, an AI/ML model of the AI system 305 may be an unsupervised learning model that is configured to discover patterns in unlabeled data to generate predictions on inputs. In another example, the AI system 305 may implement reinforcement learning models that are configured to learn behaviors through trial-and-error (e.g., via experimentation). Additionally, or alternatively, the AI system 305 may implement neural networks (e.g., artificial neural networks (ANNs)) that include one or more layers configured to process information via a series of mathematical transformations.

Deep learning models may be a subset of neural networks designed and configured for tasks such as computer vision and natural language processing and may be used by the AI system 305. In some examples, the AI system 305 may utilize a large language model (LLM) which utilizes a neural network architecture to process, understand, and generate natural language. For example, LLMs may be trained on a relatively large corpus of data (e.g., text data, image data, audio data, video data, among others) to perform natural language processing tasks such as text generation, translation, summarization, responding to natural language queries, data generation, or any combination thereof.

The AI system 305 may be an agentic AI system, meaning that the AI system 305 may act autonomously (e.g., through the use of AI agents), at least for some operations, to achieve specified goals, make decisions, and take actions without direct human intervention. In some cases, the AI system 305 may be an agentic AI system with limited human involvement where the AI system 305 may request human guidance or user input only in certain circumstances, such as if the AI system 305 is unable to make a decision or perform a subsequent operation. Further, the AI system 305 may use one or more AI/ML models to set and pursue goals 315 without those goals 315 being specifically defined by human input to the AI system 305. The AI system 305 may further generate plans 320 and execute sequences of the actions 325 to achieve those goals 315 and adapt future behavior in accordance with real-time observations and feedback about the effectiveness of the actions 325 to achieve the desired outcomes or meet targets.

For example, in some cases, utilizing one or more AI/ML models, the AI system 305 may include an autonomous pentesting service 335 and may interface with coordinators 310 that coordinate goals 315 and plans 320, actions 325, and detections 330 for achieving the goals 315. For example, for autonomous pentesting, the goals 315 of the AI system 305 may be to obtain access to data stored within a target network 110, compromise (such as by obtaining unauthorized access or deploying unauthorized software to) a domain or a network asset of the target network 110, or any combination thereof. To obtain the goals 315, the AI system 305 may generate plans 320 that are based on actions 325 and detections 330. For example, to determine a next action within a defined set of guardrails or instructions, the AI system 305 may generate a plan 320 that can include an action 325 to invoke (e.g., execute) one or more commands on a target network 110 to obtain a detection 330 from the target network 110.

In some examples, the target network 110 may include one or more network assets such as servers 120, computing devices 125, data storages 130, app(s) 140, or any combination thereof. Further, obtaining a detection 330 from the target network 110 may include the AI system 305 retrieving telemetry data from the one or more network assets of the target network 110. In some cases, telemetry data obtained from the target network 110 may include logs, traces, metrics, events, or any combination thereof from the one or more network assets of the target network 110. For example, a detection 330 may include some data that is obtained from the target network 110 via an autonomous pentest that aids the AI system 305 in achieving the goals 315. In one example, the detection 330 may include an autonomous pentest obtaining a credential that is used to gain unauthorized access to a network asset, which may be an example of one of the goals 315. In another example, a detection 330 may be the autonomous pentest detecting a set of patterns of events indicated within logs of the target network 110, which may be utilized for achieving a respective goal of the goals 315. For example, a goal may be to perform a successful credential compromise attack to gain unauthorized access to a network asset and a detection 330 may indicate information to aid an autonomous pentesting agent in performing the credential compromise attack.

In some examples, the AI system 305 may also interface with the coordinators 310 to perform autonomous pentests as described elsewhere herein, such as with reference to FIGS. 1 and 2. When performing autonomous pentests, the AI system 305 may collect and store a relatively large quantity (such as thousands, millions, billions, or trillions) of training data points or tokens for the AI system 305 to perform subsequent autonomous pentests. For example, each action 325 (e.g., command) executed via the AI system 305 may result in a collection of a relatively large quantity of training data points that indicate whether the action 325 succeeded or failed, why the action 325 succeeded or failed, which software, policies, or tools were used to execute the action 325 that resulted in the action 325 succeeding or failing, or any combination thereof. Therefore, the AI system 305 may continuously obtain and update the training data used for training AI/ML models and perform reinforcement learning using collective intelligence to improve the weights and training of the AI/ML models.

In some examples, the training data for the AI system 305 may include telemetry data obtained from the target network 110, data obtained from servers 120, computing devices 125, and app(s) 140 via a developer pipeline 340, or both. In some cases, the training data may include indications of reports 345, exploits 350, and landmarks 355. A report 345 may indicate outputs or artifacts generated by the AI system 305 to document the discoveries, vulnerabilities, and results of an autonomous pentest. An exploit 350 may indicate the tools, techniques, operations, programs, code, and the like utilized by the AI system 305 to perform an autonomous pentest. A landmark 355 may indicate a point or marker within a network (e.g., the target network 110) to assist the AI system 305 to navigate and map an environment of the target network 110 during an autonomous pentest.

In some examples, the AI system 305 may obtain the reports 345, exploits 350, and landmarks 355 based on performing one or more autonomous pentests. In another example, one or more users (e.g., developers) may manually generate the reports 345, exploits 350, and landmarks 355 for training the AI system 305. In such cases, the one or more users may generate the data for the reports 345, exploits 350, and landmarks 355 and label the data for the AI system 305. Additionally, or alternatively, one or more users may utilize an LLM to generate the reports 345, exploits 350, and landmarks 355. For example, a user may prompt an LLM to generate the reports 345, exploits 350, and landmarks 355 by providing the LLM with a set of input parameters that indicate a scope, objectives, and constraints of an autonomous pentest. In some examples, the LLM prompt to generate the reports 345, exploits 350, and landmarks 355 may be a natural language prompt that includes instructions that indicates characteristics of the target network 110, testing protocols, compliance requirements, or any combination thereof. The LLM may then process the prompt and generate the reports 345, exploits 350, and landmarks 355 for training the AI system 305.

Utilizing the reports 345, exploits 350, and landmarks 355, the AI system 305 may perform one or more autonomous pentests by maintaining awareness of the current testing state and progress through a pentest context window 360. The pentest context window 360 may process information about ongoing pentesting operations, including successfully exploited vulnerabilities, accessed systems and data, attempted but failed exploit paths, attack paths, among others.

The AI system 305 may analyze contextual information obtained from performing autonomous pentests to generate cross-pentest insights 365 that can be applied across multiple pentesting operations. For example, as a result of training the AI system 305, one or more autonomous pentests, or both, the AI system 305 may generate a set of the cross-pentest insights 365 that indicates insights 370 (e.g., an insight 370-a, an insight 370-b, an insight 370-c, an insight 370-d, an insight 370-e, and an insight 370-f). For example, the insight 370-a may indicate patterns of vulnerable default configurations in software (e.g., commonly used enterprise or commercial software). In some other examples, the insight 370-b may indicate how compromised low-privilege user credentials can be leveraged to eventually gain domain admin access through privilege escalation techniques. Further, the insight 370-c and the insight 370-d may indicate common pathways where initial network access can lead to sensitive data exposure, such as finding unencrypted password files or accessing improperly secured cloud storage buckets. The insight 370-e may indicate recurring vulnerabilities in network segmentation that allow lateral movement between supposedly isolated systems. Additionally, or alternatively, the insight 370-f may indicate patterns where seemingly low-risk misconfigurations can be chained together to achieve relatively significant compromise of the target network 110. Therefore, the cross-pentest insights 365 may indicate one or more of the insights 370 that represent patterns and vulnerabilities that occur across different networks and testing scenarios, helping organizations better understand systemic security weaknesses and how to address such weaknesses. For example, the cross-pentest insights 365 may be added as landmarks 355 for further training the AI system 305 to perform autonomous pentests.

The cross-pentest insights 365 may be displayed to computing devices 125, app(s) 140, or both to enable users to view and analyze the cross-pentest insights 365 to generate additional TTPs configured to achieve the goals 315 of the AI system 305. To display the cross-pentest insights 365 to one or more users, the AI system 305 may generate narratives 375 that indicate the insights 370 obtained in response to one or more autonomous pentests. In some examples, to generate one or more of the narratives 375, the AI system 305 may output (e.g., transmit) the cross-pentest insights 365 via a pipeline 380 connected to a separate AI/ML model (e.g., an LLM). For example, the AI system 305 may output the cross-pentest insights 365 to an LLM that is configured to generate the narratives 375 (e.g., the LLM is finetuned for text generation based on an input of the insights 370). In some cases, the narratives 375 may indicate detailed security postures for organizations, companies, tenants, users, groups of users, or any combination thereof. For example, a narrative 375 may be a compliance narrative that indicates one or more of the insights 370 about the security compliance of a target network 110. In another example, a narrative 375 may be a presentation for a company or organization that indicates the one or more vulnerabilities in a target network 110 associated with the company or organization. For example, the presentation can indicate the cross-pentest insights 365 obtained from performing one or more autonomous pentests on the target network 110 associated with the company or organization (e.g., the target network 110).

In some examples, users or devices external to the target network 110 may interact, communicate, or otherwise engage with the AI system 305 to configure pentesting parameters, perform pentesting operations on the target network 110, or analyze the results from a pentest on target network 110. For instance, a user such as a service provider for the AI system 305 may operate an external device 385 to provide information to the AI system 305 (e.g., to the coordinators 310), which identifies goals 315, plans 320, or actions 325 for pentesting the target network 110. Additionally, or alternatively, the AI system 305 may provide information, such as cross-pentest insights 365, to the external device 385. A user of the external device 385 may analyze the cross-pentest insights 365 to generate or modify narratives 375 corresponding to the results of the pentest on the target network 110. In some cases, an output of the LLM used to generate narratives 375 may be sent to the external device 385, and a user (e.g., a service provider) of the external device 385 may aggregate narratives 375 about the target network 110 for reporting or conveyance via the pentest context window 360. Alternatively, the user of the external device 385 may modify one or more of the narratives 375 based on goals 315, plans 320, detections 330, or other information such that the narratives 375 resulting from the pentest for the target network indicate the relevant and important information for identifying weaknesses and addressing vulnerabilities in the target network 110.

An autonomous pentesting service 335 may utilize the AI system 305 to generate EDR payloads to be deployed to endpoints accessed during autonomous pentests. For example, the autonomous pentesting service 335 may input information associated with an endpoint accessed during autonomous pentesting—including parameters of the endpoint, attributes of the environment surrounding the endpoint, and a complexity level associated with accessing the endpoint—into the AI system 305, and the AI system 305 may output an indication of an EDR payload recommended for EDR agent deployment. The EDR payload may include a configuration that blocks attack vectors (or attack paths) used to access the endpoint during the autonomous pentest. As an example, if the autonomous pentesting service 335 accessed the endpoint via an vulnerable web application, the EDR payload may be configured to block a listening port for that vulnerable web application.

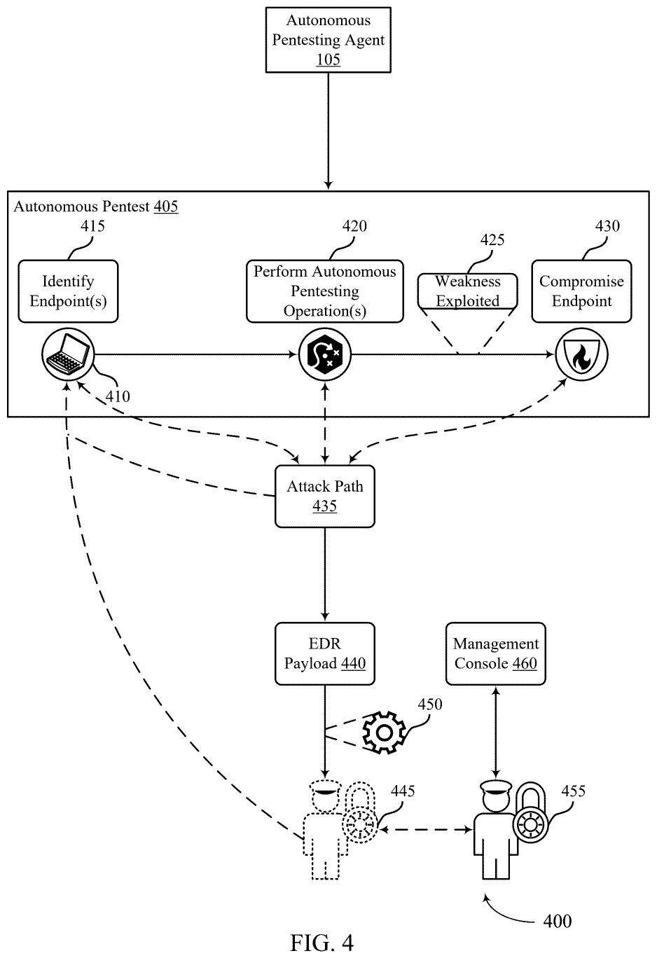

FIG. 4 shows an example of a pentesting flow diagram 400 that supports self-contained EDR configuration and deployment in autonomous pentesting in accordance with aspects of the present disclosure. The pentesting flow diagram 400 may implement or be implemented by the computing environment 100, the autonomous pentest map 200, the computing environment 300, or any combination thereof. For example, the pentesting flow diagram 400 may illustrate an autonomous pentest 405 performed by an autonomous pentesting agent 105 involving identification of an endpoint 410 and deployment of an EDR agent 445 to the endpoint 410.

The autonomous pentesting agent 105 may execute an autonomous pentest 405 on a network, such as the target network 110 described with reference to FIG. 1. The autonomous pentesting agent 105 may identify, enumerate, and exploit vulnerabilities in the network. For example, the autonomous pentesting agent 105 may identify endpoint(s) at 415, including an endpoint 410. As an example, the autonomous pentesting agent 105 may perform a scan of the target network to identify one or more endpoints. The endpoint 410 may be an example of a network asset—such as a network asset described with reference to FIG. 1—that connects to and exchanges information with a network (such as the target network 110). Endpoints may be examples of physical or virtual devices, including mobile devices, desktop computers, virtual machines, embedded devices, servers, IoT devices, or the like.

During the autonomous pentest 405, the autonomous pentesting agent 105 may perform autonomous pentesting operation(s) at 420 along an attack path 435. In some examples, the autonomous pentesting agent 105 may target the endpoint 410 via the autonomous pentesting operation(s). For example, the autonomous pentesting agent 105 may perform autonomous pentesting operation(s) along the attack path 435 and, at 425, exploit a weakness of the endpoint 410. By exploiting the weakness, the autonomous pentesting agent 105 may compromise the endpoint 410 at 425. As used herein, compromising the endpoint may also be referred to as accessing (e.g., gaining unauthorized access to) the endpoint 410, data on the endpoint 410, services on the endpoint 410, or the like. In other words, the autonomous pentesting agent 105 may compromise the endpoint 410 by obtaining unauthorized access to the endpoint 410. The autonomous pentesting agent 105 may be capable of executing code at the endpoint 410 based on compromising the endpoint at 425. In other words, once the endpoint 410 is compromised—such as through stolen credentials, lateral movement, or a remote code execution exploit—the autonomous pentesting agent 105 may gain the ability to run code on the endpoint 410. This capability may allow the autonomous pentesting agent 105 to perform operations including file system operations, configuration modification, or software installation—such as installation of an EDR agent 445—remotely and without user interaction.

The autonomous pentesting agent 105 may generate an EDR payload 440 based on the autonomous pentest 405. For example, the autonomous pentesting agent 105 may generate an EDR payload 440 having a configuration 450 for an EDR agent 445. The configuration 450 may be fixed and set prior to deployment of the EDR agent 445. For example, the EDR agent 445 may be an example of a self-contained EDR agent, and after deployment, the EDR agent 445 may not communicate with any other entities. In other words, in contrast to an EDR agent 455 that is configured to communicate with a management console 460, the EDR agent 445 may not communicate with the management console 460 or other entities (including the autonomous pentesting agent 105) after deployment. Put another way, the EDR agent 445 may operate independently based on embedded logic rather than based on external controls or a combination of embedded logic and external controls. For example, the embedded logic may include static rule sets or lightweight behavioral heuristics designed to detect and block specific classes or types of attacks or specific operations identified during the pentest. The EDR agent 445 operating independently and without communication with other entities may be referred to herein as operating “offline” or as the EDR agent 445 being self-contained.

The autonomous pentesting agent 105 may determine the configuration 450 based on information obtained during the autonomous pentest 405. For example, the configuration 450 may be based on the attack path 435 by which the endpoint 410 was compromised. Specifically, the autonomous pentesting agent 105 may configure the EDR agent 445 to block processes corresponding to the autonomous pentesting operations performed at 420 to compromise the endpoint 410 at 430. As an example, the autonomous pentesting agent 105 may configure the EDR agent 445 to block processes that correspond to a webserver exploit, an LSASS dump, or the like. By configuring the EDR agent 445 in accordance with the attack path 435, the autonomous pentesting agent 105 may patch (e.g., remediate) the weakness used to compromise the endpoint 410 while permitting other operations within the target network, thereby avoiding degradation to user experience.

In some examples, the configuration 450 may include a whitelist. For example, the configuration 450 may include a set of permitted processes. If the EDR agent 445 detects a process that is not included in the set of permitted processes, the EDR agent 445 may block the process. Alternatively, if the EDR agent 445 detects a process that is included in the set of permitted processes, the EDR agent 445 may allow the process. Additionally, or alternatively, the configuration 450 may include a firewall rule. For example, the configuration 450 may indicate one or more ports that are to be blocked at the endpoint 410. As an example, the configuration 450 may block use of one or more ports used in the attack path 435. In another example, the EDR agent 445 may be configured to block all processes at the endpoint 410 (e.g., shut down the endpoint 410 such that it cannot be used).

The autonomous pentesting agent 105 may tune an aggressiveness (e.g., an aggression level) of the EDR agent 445. For example, the autonomous pentesting agent 105 may determine the configuration 450 of the EDR agent 445, which may define which processes are to be blocked by the EDR agent 445. That is, the configuration 450 may include an aggressiveness, which may refer to an amount or types of different processes blocked by the EDR agent 445 (e.g., a high aggressiveness involving blocking a relatively large amount or types of processes, and a low aggressiveness involving blocking a relatively low amount or types of processes). A type of process may refer to a type of communication routed in and out of the endpoint 410, processes related to different applications or services or types thereof, or the like. As an example, the autonomous pentesting agent 105 may tune the aggressiveness to block all processes related to file sharing applications but not mail servers.

The configuration 450 may include an expiry condition. That is, the EDR agent 445 may be configured to disable after the expiry condition is met. In a first example, the expiry condition may be expiration of a timer. For example, the EDR agent 445 may include a timer that is initiated when the EDR agent 445 is deployed. In such examples, the EDR agent 445 may uninstall itself when the timer expires. In a second example, the expiry condition may be activation of the EDR agent 455 which is configured to communicate with the management console 460. For example, the EDR agent 445 may disable (e.g., uninstall itself or be manually uninstalled by a user) when another EDR agent 455 is activated on the endpoint 410. The EDR agent 445 may be configured to detect one or more EDR vendors (e.g., CrowdStrike, SentinelOne, etc.) and identify an occurrence of the expiry condition based on detection of an EDR vendor of the one or more EDR vendors. In such examples, the EDR agent 455 may be of a different type than the EDR agent 445. That is, the EDR agent 455—rather than being self-contained and offline—may communicate with a management console 460, be part of an EDR system, or both. For example, the EDR agent 455 may have a flexible configuration that is capable of being changed after the EDR agent 455 is deployed, such as via communication with the management console 460. Additionally, the EDR agent 455 may report activity at the endpoint 410 to the management console 460, whereas the EDR agent 445 may lack the capability to report to any external entity.

In some examples, the autonomous pentesting agent 105 may remediate the weakness in addition to, or alternatively from, deploying the EDR agent 445. That is, the autonomous pentesting agent 105 may, after exploiting the weakness to compromise the endpoint 410, perform one or more remediation operations such that the weakness is no longer present or exploitable at the endpoint 410. Put another way, the autonomous pentesting agent 105 may perform auto-remediation.

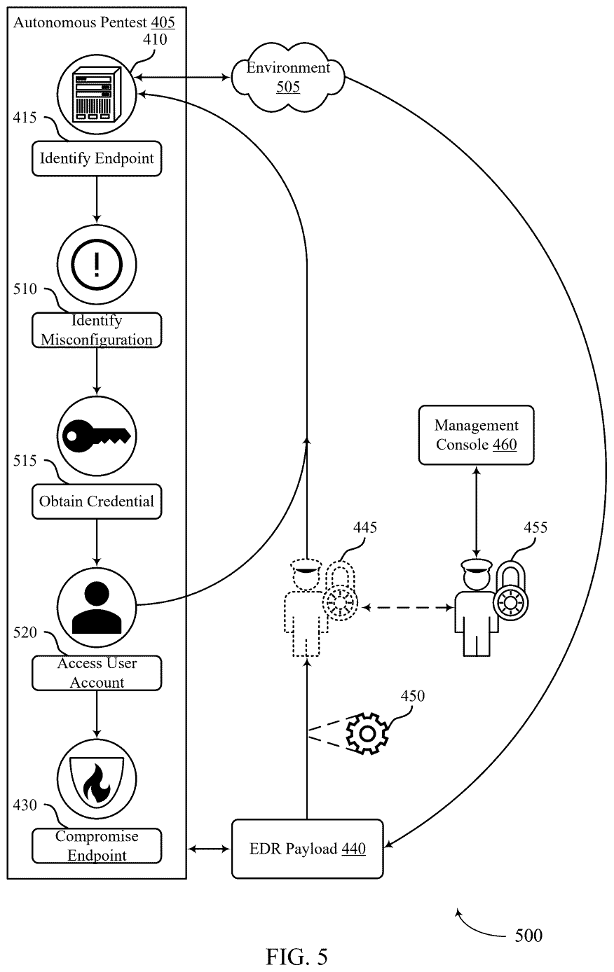

To deploy the EDR agent 445 at the endpoint 410, the autonomous pentesting agent 105 may use the attack path 435 by which the endpoint 410 was compromised. For example, the autonomous pentesting agent 105 may employ the same attack vectors used to gain initial access to the endpoint 410 to deploy the EDR agent 445. The attack vectors (and deployment techniques) may include remote code execution exploits, stolen or cracked credentials, and built-in OS tools—which may be referred to as “living-off-the-land” (LOL) techniques. For example, the autonomous pentesting agent 105 may identify domain or local administrator credentials during the autonomous pentest 405 and use the credentials along with a software deployment mechanism (e.g., built-in tools such as a Group Policy for Windows OSs, PowerShell, Windows Management Instrumentation (WMI), command line tools, or the like) or remote service creation available to domain or local administrator accounts to install and configure the EDR agent 445. An example of using credentials obtained during the autonomous pentest 405 to deploy the EDR agent 445 is described in greater detail elsewhere herein, including with reference to FIG. 5. In another example, the autonomous pentesting agent 105 may use remote script execution to deploy the EDR agent 445. For example, the autonomous pentesting agent 105 may drop and execute an installer (e.g., a Microsoft Software Installer (MSI) or an executable (EXE) file) on the endpoint 410. Additionally, or alternatively, the autonomous pentesting agent 105 may integrate with enterprise security management consoles or application programming interfaces (APIs) of the network to initiate EDR deployment from a trusted central location.

FIG. 5 shows an example of a pentesting flow diagram 500 that supports self-contained EDR configuration and deployment in autonomous pentesting in accordance with aspects of the present disclosure. The pentesting flow diagram 500 may implement or be implemented by the computing environment 100, the autonomous pentest map 200, the computing environment 300, the pentesting flow diagram 400, or any combination thereof. For example, the pentesting flow diagram 500 may illustrate an autonomous pentest 405 involving compromising an endpoint 410 and deploying an EDR agent 445 to the endpoint 410.

An autonomous pentesting agent may execute an autonomous pentest 405 of a target network. At 415, the autonomous pentest 405 may include identifying an endpoint 410 (e.g., a server). Additionally, at 510, the autonomous pentest 405 may include identifying a misconfiguration at the endpoint 410. For example, the autonomous pentesting agent may identify that an EDR agent at the endpoint 410 (e.g., installed or activated prior to the autonomous pentest 405) includes a monitoring configuration that fails to detect one or more operations by the autonomous pentesting agent. The autonomous pentesting agent may, via the misconfiguration, obtain a credential at 515 and use the credential to access a user account at 520. Then, at 430, the autonomous pentesting agent may compromise the endpoint 410 at 425 based on accessing the user account.

After compromising the endpoint 410, the autonomous pentesting agent may generate an EDR payload 440. For example, the autonomous pentesting agent may generate the EDR payload 440 based on one or more parameters of the endpoint 410, one or more attributes of an environment 505 surrounding the endpoint 410, and a complexity level associated with accessing the endpoint 410 via one or more autonomous pentesting operations along an attack path. That is, the autonomous pentesting agent may generate the EDR payload 440 such that the EDR agent 445 is configured to block processes corresponding to an attack path by which the endpoint 410 was compromised. In the example of FIG. 5, the EDR agent 445 may be configured to block processes associated with an LSASS dump, which the autonomous pentesting agent may have used to obtain the credential at 515.

The autonomous pentesting agent may deploy an EDR installer using management tools and the user account accessed at 520. For example, the user account may have a capability or privilege to install software on the endpoint 410, and the autonomous pentesting agent may use the capability to install the EDR agent 445 at the endpoint 410. The EDR agent 445 may include the EDR payload 440 and may have a configuration 450 that defines which processes are to be blocked and/or which processes are to be permitted at the endpoint 410. Additionally, the configuration 450 may define an expiry condition associated with the EDR agent 445 (e.g., a condition which, if met, triggers the EDR agent 445 to disable).

The EDR agent 445 may monitor the endpoint 410 and, in some examples, block one or more processes at the endpoint 410 in accordance with the configuration 450. For example, the EDR agent 445 may detect and block processes associated with an LSASS dump. Additionally, the EDR agent 445, after being deployed to the endpoint 410, may detect the expiry condition. In a first example, the EDR agent 445 may identify that a timer has expired, thereby triggering the EDR agent 445 to disable. In a second example, the EDR agent 445 may detect activation of the EDR agent 455, which is configured to communicate with the management console 460.

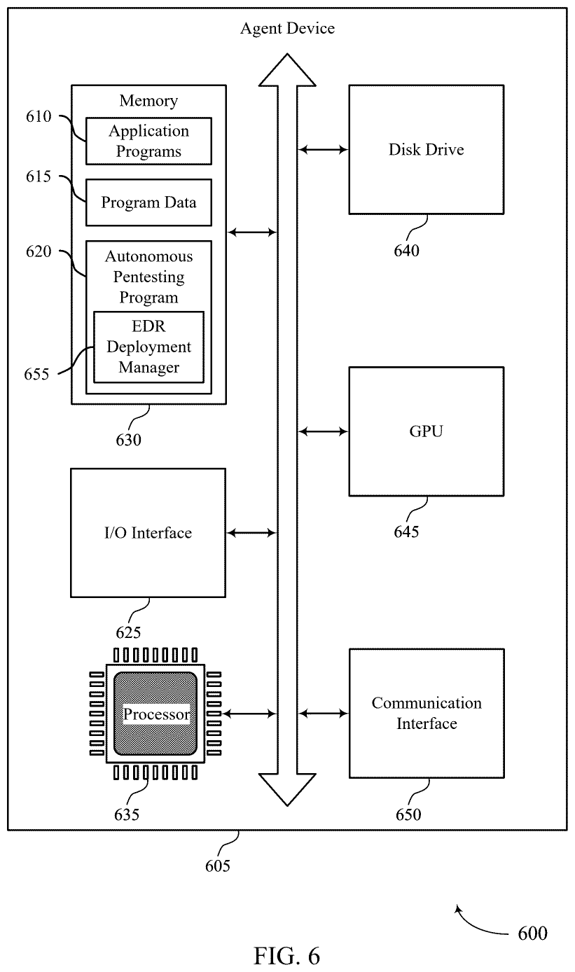

FIG. 6 shows a diagram of a system 600 including an agent device 605 that supports self-contained EDR configuration and deployment in autonomous pentesting in accordance with aspects of the present disclosure. The agent device 605 may be an example of a device or server on which an autonomous pentesting agent 105 is deployed as described herein. The agent device 605 may include components for self-contained EDR configuration and deployment in autonomous pentesting, such as a memory 630 including application programs 610, program data 615, an autonomous pentesting program 620, and a EDR deployment manager 655; an input/output (I/O) interface 625; a processor 635; a disk drive 640; a graphics processing unit (GPU) 645; and a communication interface 650. Each of these components may communicate, directly or indirectly, with one another (e.g., via one or more buses, communications links, communications interfaces, or any combination thereof).

The I/O interface 625 may support connection of the agent device 605 with one or more other devices. For example, the agent device 605 may connect to keyboards, mice, printers, hard disks, or the like via the I/O interface 625. The I/O interface 625 may communicate with the processor 635. That is, the processor 635 may process signals from devices connected to the agent device 605 via the I/O interface 625.

Memory 630 may include RAM, ROM, or both. The memory 630 may store computer-readable, computer-executable software including instructions that, when executed, cause at least one processor 635 to perform various functions described herein, such as functions supporting self-contained EDR configuration and deployment in autonomous pentesting. In some cases, the memory 630 may contain, among other things, a basic input/output system (BIOS), which may control basic hardware or software operation such as the interaction with peripheral components or devices. The memory 630 may be an example of a single memory or multiple memories. For example, the agent device 605 may include one or more memories 630.

The application programs 610 in the memory 630 may be examples of app(s) 140 as described with reference to FIG. 1. For example, the application programs 610 may be installed on the memory 630 of the agent device 605, among other devices in a network. The application programs 610 may be examples of software applications or computer programs that are implemented to carry out one or more functions or tasks.

The program data 615 may be data related to the application programs 610. Program data 615 may be an example of or refer to running data of programs and applications installed on the memory 630 of the agent device 605. In some examples, the program data 615 may include various data, including code that allows the application programs 610 to perform the one or more functions or tasks.

The processor 635 may include an intelligent hardware device, (e.g., a general-purpose processor, a digital signal processor (DSP), a CPU, a microcontroller, an application-specific integrated circuit (ASIC), a field programmable gate array (FPGA), a programmable logic device, a discrete gate or transistor logic component, a discrete hardware component, or any combination thereof). The processor 635 may be configured to execute computer-readable instructions stored in at least one memory 630 to perform various functions (e.g., functions or tasks supporting self-contained EDR configuration and deployment in autonomous pentesting). Though a single processor 635 is depicted in the example of FIG. 6, it is to be understood that the system 600 may include any quantity of one or more of processors 635 and that a group of processors 635 may collectively perform one or more functions ascribed herein to a processor, such as the processor 635. The processor 635 may be an example of a single processor or multiple processors. For example, the agent device 605 may include one or more processors 635.

The disk drive 640 may be configured to store data that is generated, processed, stored, or otherwise used by the system 600. In some cases, the disk drive 640 may include one or more hard disk drives (HDDs), one or more solid-state drives (SSDs), or both. In some examples, the disk drive 640 may be an example of a single database, a distributed database, multiple distributed databases, a data store, a data lake, or an emergency backup database. In some examples, the disk drive 640 may be an example of one or more components described with reference to FIG. 1.

GPU 645 may be configured to store graphics-related data. The GPU 645 may store and manage data related to graphics and video processing. In some examples, the GPU 645 may be an example of or a component of a graphics card. The GPU 645 may use components of the memory 630, including the RAM, for temporary storage. For example, the GPU 645 may move data from the RAM of the memory 630 to the GPU 645 for graphics and video processing.

The communication interface 650 may enable the agent device 605 to exchange information (e.g., input information, output information, or both) with other systems or devices (not shown). For example, the communication interface 650 may enable the agent device 605 to connect to a network (e.g., a target network 110 as described herein). The communication interface 650 may include one or more wireless network interfaces, one or more wired network interfaces, or any combination thereof.

The autonomous pentesting program 620 may be an example of a program of an autonomous pentesting service that is installed on the memory 630 of the agent device 605. The autonomous pentesting program 620 may execute an autonomous pentest of a network (e.g., a target network 110 as described herein) accessed by the agent device 605, such as accessed via the communication interface 650. That is, the autonomous pentesting program 620 may be configured to perform an autonomous pentest as described herein, including an autonomous pentest involving autonomous pentesting.

The EDR deployment manager 655 may support autonomous pentesting in accordance with examples as disclosed herein. For example, the EDR deployment manager 655 may be configured as or otherwise support a means for executing an autonomous pentest of a network, where executing the autonomous pentest includes: performing one or more autonomous pentesting operations along an attack path, and accessing an endpoint of multiple endpoints of the network via the attack path. The EDR deployment manager 655 may be configured as or otherwise support a means for generating an EDR payload based on one or more parameters of the endpoint, one or more attributes of an environment surrounding the endpoint, and a complexity level associated with accessing the endpoint via the one or more autonomous pentesting operations along the attack path. The EDR deployment manager 655 may be configured as or otherwise support a means for deploying, via the attack path and during the autonomous pentest, an EDR agent including the EDR payload at the endpoint, where the EDR agent is configured to disable after an expiry condition is met.

By including or configuring the EDR deployment manager 655 in accordance with examples as described herein, the agent device 605 may support techniques for improved network security.

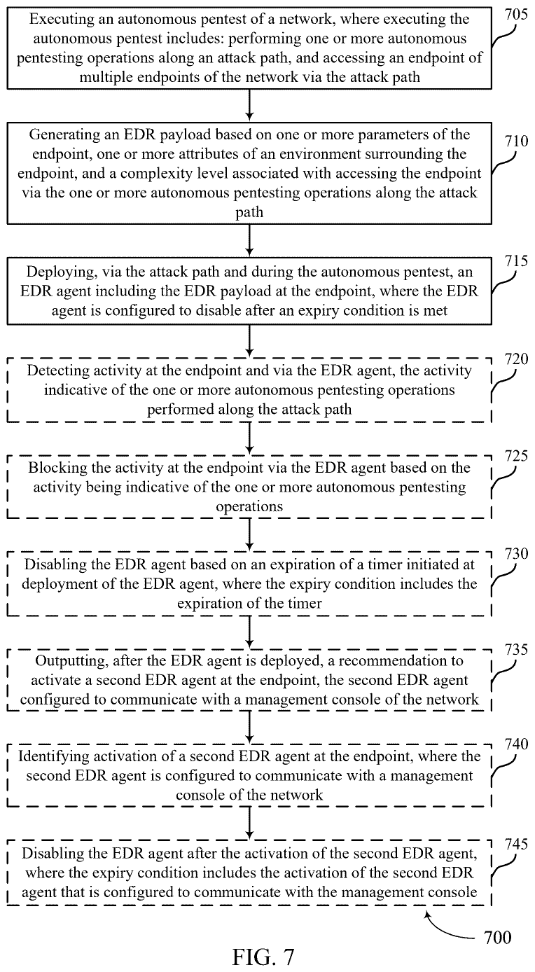

FIG. 7 shows a flowchart illustrating a method 700 that supports self-contained EDR configuration and deployment in autonomous pentesting in accordance with aspects of the present disclosure. The operations of the method 700 may be implemented by an agent device 605 or its components as described herein. In some examples, an agent device may execute a set of instructions to control the functional elements of the agent device to perform the described functions. Additionally, or alternatively, the agent device may perform aspects of the described functions using special-purpose hardware.

At 705, the method 700 may include executing an autonomous pentest of a network, where executing the autonomous pentest includes: performing one or more autonomous pentesting operations along an attack path, and accessing an endpoint of multiple endpoints of the network via the attack path.

At 710, the method 700 may include generating an EDR payload based on one or more parameters of the endpoint, one or more attributes of an environment surrounding the endpoint, and a complexity level associated with accessing the endpoint via the one or more autonomous pentesting operations along the attack path.

At 715, the method 700 may include deploying, via the attack path and during the autonomous pentest, an EDR agent including the EDR payload at the endpoint, where the EDR agent is configured to disable after an expiry condition is met.

At 720, the method 700 may include detecting activity at the endpoint and via the EDR agent, the activity indicative of the one or more autonomous pentesting operations performed along the attack path.

At 725, the method 700 may include blocking the activity at the endpoint via the EDR agent based on the activity being indicative of the one or more autonomous pentesting operations.

At 730, the method 700 may include disabling the EDR agent based on an expiration of a timer initiated at deployment of the EDR agent, where the expiry condition includes the expiration of the timer.

At 735, the method 700 may include outputting, after the EDR agent is deployed, a recommendation to activate a second EDR agent at the endpoint, the second EDR agent configured to communicate with a management console of the network.

At 740, the method 700 may include identifying activation of a second EDR agent at the endpoint, where the second EDR agent is configured to communicate with a management console of the network.

At 745, the method 700 may include disabling the EDR agent after the activation of the second EDR agent, where the expiry condition includes the activation of the second EDR agent that is configured to communicate with the management console.

The following provides an overview of aspects of the present disclosure:
Aspect 1: A method for autonomous pentesting, comprising: executing an autonomous pentest of a network, wherein executing the autonomous pentest comprises: performing one or more autonomous pentesting operations along an attack path; and accessing an endpoint of a plurality of endpoints of the network via the attack path; generating an EDR payload based at least in part on one or more parameters of the endpoint, one or more attributes of an environment surrounding the endpoint, and a complexity level associated with accessing the endpoint via the one or more autonomous pentesting operations along the attack path; and deploying, via the attack path and during the autonomous pentest, an EDR agent comprising the EDR payload at the endpoint, wherein the EDR agent is configured to disable after an expiry condition is met.
Aspect 2: The method of aspect 1, further comprising: disabling the EDR agent based at least in part on an expiration of a timer initiated at deployment of the EDR agent, wherein the expiry condition comprises the expiration of the timer.
Aspect 3. The method of any of aspects 1 through 2, further comprising: identifying activation of a second EDR agent at the endpoint, wherein the second EDR agent is configured to communicate with a management console of the network; and disabling the EDR agent after the activation of the second EDR agent, wherein the expiry condition comprises the activation of the second EDR agent that is configured to communicate with the management console.
Aspect 4: The method of any of aspects 1 through 3, further comprising: outputting, after the EDR agent is deployed, a recommendation to activate a second EDR agent at the endpoint, the second EDR agent configured to communicate with a management console of the network.
Aspect 5: The method of aspect 4, wherein the recommendation indicates the expiry condition associated with the EDR agent and recommends activation of the second EDR agent prior to occurrence of the expiry condition.
Aspect 6: The method of any of aspects 1 through 5, further comprising: detecting activity at the endpoint and via the EDR agent, the activity indicative of the one or more autonomous pentesting operations performed along the attack path; and blocking the activity at the endpoint via the EDR agent based at least in part on the activity being indicative of the one or more autonomous pentesting operations.
Aspect 7: The method of any of aspects 1 through 6, further comprising: detecting activity at the endpoint and via the EDR agent; and permitting or blocking the activity based at least in part on whether a set of permissible activities configured at the EDR agent comprises the activity.
Aspect 8: The method of any of aspects 1 through 7, wherein the EDR agent is self-contained such that information associated with operations performed by the EDR is accessible only by the EDR agent.
Aspect 9: The method of any of aspects 1 through 8, wherein the EDR agent is offline and comprises embedded logic configured to monitor the endpoint and block one or more actions.
Aspect 10: The method of any of aspects 1 through 9, further comprising: obtaining a capability to execute code at the endpoint based at least in part on the one or more autonomous pentesting operations performed along the attack path, wherein the EDR agent is deployed using the capability to execute code at the endpoint.
Aspect 11: The method of aspect 10, wherein deploying the EDR agent comprises: remotely executing code at the endpoint using the capability obtained based at least in part on the one or more autonomous pentesting operations, wherein executing the code deploys the EDR agent at the endpoint.
Aspect 12: The method of any of aspects 1 through 11, further comprising: identifying, during the autonomous pentest, credentials associated with software installation permissions, the software installation permissions applicable to the endpoint.
Aspect 13: The method of aspect 12, wherein deploying the EDR agent comprises: installing the EDR agent at the endpoint using the credentials and based at least in part on the software installation permissions associated with the credentials.
Aspect 14: The method of any of aspects 1 through 13, further comprising: identifying, during the autonomous pentest of the network, a misconfiguration of a second EDR agent at the endpoint, wherein: accessing the endpoint is based at least in part on the misconfiguration; and the EDR agent replaces the second EDR agent and is configured to address the misconfiguration used to access the endpoint during the autonomous pentest.
Aspect 15: The method of any of aspects 1 through 14, further comprising: determining, before deploying the EDR agent, an EDR configuration based at least in part on the one or more parameters of the endpoint, the one or more attributes of the environment surrounding the endpoint, and the complexity level associated with accessing the endpoint via the one or more autonomous pentesting operations along the attack path, wherein: the EDR configuration defines one or more processes to be blocked by the EDR agent, and the EDR payload is generated in accordance with the EDR configuration.
Aspect 16: An apparatus for autonomous pentesting, comprising: one or more memories storing processor-executable code; and one or more processors coupled with the one or more memories and individually or collectively operable to execute the code to cause the apparatus to perform a method of any of aspects 1 through 15.
Aspect 17: A non-transitory computer-readable medium storing code for autonomous pentesting, the code comprising instructions executable by one or more processors to perform a method of any of aspects 1 through 15.
Aspect 18: An apparatus for autonomous pentesting, comprising at least one means for performing a method of any aspects 1 through 15.

It should be noted that these methods describe examples of implementations, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

Information and signals described herein may be represented using any of a variety of different technologies and techniques. For example, data, instructions, commands, information, signals, bits, and symbols that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). The functions of each unit may also be implemented, in whole or in part, with instructions embodied in a memory, formatted to be executed by one or more general or application-specific processors.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for autonomous pentesting, comprising:
executing an autonomous pentest of a network, wherein executing the autonomous pentest comprises:
performing one or more autonomous pentesting operations along an attack path; and
accessing an endpoint of a plurality of endpoints of the network via the attack path;
generating an endpoint detection and response (EDR) payload based at least in part on one or more parameters of the endpoint, one or more attributes of an environment surrounding the endpoint, and a complexity level associated with accessing the endpoint via the one or more autonomous pentesting operations along the attack path; and
deploying, via the attack path and during the autonomous pentest, an EDR agent comprising the EDR payload at the endpoint, wherein the EDR agent is configured to disable after an expiry condition is met.

2. The method of claim 1, further comprising:
disabling the EDR agent based at least in part on an expiration of a timer initiated at deployment of the EDR agent, wherein the expiry condition comprises the expiration of the timer.

3. The method of claim 1, further comprising:
identifying activation of a second EDR agent at the endpoint, wherein the second EDR agent is configured to communicate with a management console of the network; and
disabling the EDR agent after the activation of the second EDR agent, wherein the expiry condition comprises the activation of the second EDR agent that is configured to communicate with the management console.

4. The method of claim 1, further comprising:
outputting, after the EDR agent is deployed, a recommendation to activate a second EDR agent at the endpoint, the second EDR agent configured to communicate with a management console of the network.

5. The method of claim 4, wherein the recommendation indicates the expiry condition associated with the EDR agent and recommends activation of the second EDR agent prior to occurrence of the expiry condition.

6. The method of claim 1, further comprising:
detecting activity at the endpoint and via the EDR agent, the activity indicative of the one or more autonomous pentesting operations performed along the attack path; and
blocking the activity at the endpoint via the EDR agent based at least in part on the activity being indicative of the one or more autonomous pentesting operations.

7. The method of claim 1, further comprising:
detecting activity at the endpoint and via the EDR agent; and
permitting or blocking the activity based at least in part on whether a set of permissible activities configured at the EDR agent comprises the activity.

8. The method of claim 1, wherein the EDR agent is self-contained such that information associated with operations performed by the EDR is accessible only by the EDR agent.

9. The method of claim 1, wherein the EDR agent is offline and comprises embedded logic configured to monitor the endpoint and block one or more actions.

10. The method of claim 1, further comprising:
obtaining a capability to execute code at the endpoint based at least in part on the one or more autonomous pentesting operations performed along the attack path, wherein the EDR agent is deployed using the capability to execute code at the endpoint.

11. The method of claim 10, wherein deploying the EDR agent comprises:
remotely executing code at the endpoint using the capability obtained based at least in part on the one or more autonomous pentesting operations, wherein executing the code deploys the EDR agent at the endpoint.

12. The method of claim 1, further comprising:
identifying, during the autonomous pentest, credentials associated with software installation permissions, the software installation permissions applicable to the endpoint.

13. The method of claim 12, wherein deploying the EDR agent comprises:
installing the EDR agent at the endpoint using the credentials and based at least in part on the software installation permissions associated with the credentials.

14. The method of claim 1, further comprising:
identifying, during the autonomous pentest of the network, a misconfiguration of a second EDR agent at the endpoint, wherein:
accessing the endpoint is based at least in part on the misconfiguration; and
the EDR agent replaces the second EDR agent and is configured to address the misconfiguration used to access the endpoint during the autonomous pentest.

15. The method of claim 1, further comprising:
determining, before deploying the EDR agent, an EDR configuration based at least in part on the one or more parameters of the endpoint, the one or more attributes of the environment surrounding the endpoint, and the complexity level associated with accessing the endpoint via the one or more autonomous pentesting operations along the attack path, wherein:
the EDR configuration defines one or more processes to be blocked by the EDR agent, and
the EDR payload is generated in accordance with the EDR configuration.

16. An apparatus for autonomous pentesting, comprising:
one or more memories storing processor-executable code; and
one or more processors coupled with the one or more memories and individually or collectively operable to execute the code to cause the apparatus to:
execute an autonomous pentest of a network, wherein, to execute the autonomous pentest, the one or more processors are individually or collectively further operable to execute the code to cause the apparatus to:
perform one or more autonomous pentesting operations along an attack path; and
access an endpoint of a plurality of endpoints of the network via the attack path;
generate an endpoint detection and response (EDR) payload based at least in part on one or more parameters of the endpoint, one or more attributes of an environment surrounding the endpoint, and a complexity level associated with accessing the endpoint via the one or more autonomous pentesting operations along the attack path; and
deploy, via the attack path and during the autonomous pentest, an EDR agent comprising the EDR payload at the endpoint, wherein the EDR agent is configured to disable after an expiry condition is met.

17. The apparatus of claim 16, wherein the one or more processors are individually or collectively further operable to execute the code to cause the apparatus to:
disable the EDR agent based at least in part on an expiration of a timer initiated at deployment of the EDR agent, wherein the expiry condition comprises the expiration of the timer.

18. The apparatus of claim 16, wherein the one or more processors are individually or collectively further operable to execute the code to cause the apparatus to:
identify activation of a second EDR agent at the endpoint, wherein the second EDR agent is configured to communicate with a management console of the network; and
disable the EDR agent after the activation of the second EDR agent, wherein the expiry condition comprises the activation of the second EDR agent that is configured to communicate with the management console.

19. A non-transitory computer-readable medium storing code for autonomous pentesting, the code comprising instructions executable by one or more processors to:
execute an autonomous pentest of a network, wherein, to execute the autonomous pentest, the instructions are further executable by the one or more processors to:
perform one or more autonomous pentesting operations along an attack path; and
access an endpoint of a plurality of endpoints of the network via the attack path;
generate an endpoint detection and response (EDR) payload based at least in part on one or more parameters of the endpoint, one or more attributes of an environment surrounding the endpoint, and a complexity level associated with accessing the endpoint via the one or more autonomous pentesting operations along the attack path; and
deploy, via the attack path and during the autonomous pentest, an EDR agent comprising the EDR payload at the endpoint, wherein the EDR agent is configured to disable after an expiry condition is met.

20. The non-transitory computer-readable medium of claim 19, wherein the instructions are further executable by the one or more processors to:
disable the EDR agent based at least in part on an expiration of a timer initiated at deployment of the EDR agent, wherein the expiry condition comprises the expiration of the timer.
